(19) United States
(12) Patent Application Publication
(10) Pub. No.: US 2020/0218290 A1
(43) Pub. Date: Jul. 9, 2020

(54) Methods and Systems for Selective Attachment and Use of Unmanned Aircraft Suspension Perches

(71) Applicant: Motorola Mobility LLC, Chicago, IL (US)

(72) Inventors: John Gorsica, Round Lake, IL (US); Rachid Alameh, Crystal Lake, IL (US); Yi Wu, Chicago, IL (US); Zhengping Ji, Hinsdale, IL (US); Thomas Gitzinger, Libertyville, IL (US)

(21) Appl. No.: 16/242,989

(22) Filed: Jan. 8, 2019

(51) Int. Cl. G05D 1/12; G05D 1/10; B64F 1/36; G01C 21/20

(52) U.S. Cl. CPC G05D 1/12; G01C 21/20; B64F 1/36; G05D 1/101

(57) ABSTRACT

Methods and systems for attaching an unmanned aircraft suspension perch to a surface with an unmanned aircraft are provided. One method includes retrieving, with the unmanned aircraft, the unmanned aircraft suspension perch. The method can include selecting, with one or more processors carried by the unmanned aircraft, an attachment location for the unmanned aircraft suspension perch. A flight engine responsive to the one or more processors can navigate the unmanned aircraft to the attachment location. The unmanned aircraft can attach the unmanned aircraft suspension perch to the surface at the attachment location. The unmanned aircraft can then suspend itself from the unmanned aircraft suspension perch, or alternatively release, with a perch interface of the unmanned aircraft, the unmanned aircraft suspension perch while the unmanned aircraft suspension perch remains attached to the surface at the attachment location.

### BACKGROUND

### TECHNICAL FIELD

This disclosure relates generally to unmanned aircraft, and more particularly to methods and systems for unmanned aircraft.

### BACKGROUND ART

The use of unmanned aircraft, commonly known as “drones,” is becoming more popular.

Drones can be equipped with cameras to capture images or video from elevated locations. Hobbyists use drones for recreational purposes, while professionals use drones for professional purposes. Drones are typically manufactured to be light in construction, thereby making flight more efficient. One challenge with drones is energy storage capacity. Larger batteries make drones heavier. Lighter batteries mean shorter flight times. It would be advantageous to have improved methods and systems for unmanned aircraft that reduce power consumption.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include and explain various principles and advantages embodiments of the disclosure.

FIG. 1 illustrates one explanatory system in accordance with one or more embodiments of the disclosure.

FIG. 2 illustrates one explanatory unmanned aircraft in accordance with one or more embodiments of the disclosure.

FIG. 3 illustrates explanatory unmanned aircraft suspension perch types configured in accordance with one or more embodiments of the disclosure.

FIG. 4 illustrates a schematic block diagram of one or more passive unmanned suspension perches in accordance with one or more embodiments of the disclosure.

FIG. 5 illustrates a schematic block diagram of one or more active unmanned suspension perches in accordance with one or more embodiments of the disclosure.

FIG. 6 illustrates one explanatory method in accordance with one or more embodiments of the disclosure.

FIG. 7 illustrates another explanatory method in accordance with one or more embodiments of the disclosure.

FIG. 8 illustrates still another explanatory method in accordance with one or more embodiments of the disclosure.

FIG. 9 illustrates yet another explanatory method in accordance with one or more embodiments of the disclosure.

FIG. 10 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to selectively attaching and detaching unmanned aircraft suspension perches, from which an unmanned aircraft can hang, to a surface or other object at an attachment location within an environment. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to unmanned aircraft and/or the associated user interface technology, improve the functioning of the unmanned aircraft itself by reducing the amount of power consumed in an unmanned aircraft when it is suspended from a perch to overcome problems specifically arising in the realm of the technology associated with unmanned aircraft usage.

It will be appreciated that embodiments of the disclosure described herein may be comprised of one or more conventional processors and unique stored program instructions that control the one or more processors to implement, in conjunction with certain non-processor circuits, some, most, or all of the functions of causing unmanned aircraft to retrieve unmanned aircraft suspension perches, attach them to surfaces, detach them from surfaces, select optimal locations for mission completion and/or photovoltaic charging, and suspend from these perches, as described herein. The non-processor circuits may include, but are not limited to, a radio receiver, a radio transmitter, signal drivers, clock circuits, power source circuits, and user input devices. As such, these functions may be interpreted as steps of a method to perform the steps of selectively attaching perches to surfaces, suspending from perches, detaching perches, or selecting perch locations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide systems and methods that allow an unmanned aircraft, also known as an “unmanned aerial vehicle” or “UAV” or “drone,” to install a perching fixture for reattachment by the drone to the perch at a later time. In one or more embodiments, the drone is also able to best identify an attachment location to, for example, optimize photovoltaic cell charging. As used here, “unmanned aircraft,” “unmanned aerial vehicle,” “UAV,” and “drone” refer interchangeably herein to flying machines that are controlled remotely by an operator, whether man or machine, and that do not have a biological pilot onboard. Illustrating by example, an unmanned aircraft or drone can include a vehicle capable of flight or navigation without the assistance of an onboard, human pilot, relying instead upon flight and navigation commands received wirelessly from a remotely controlled device.

Embodiments of the disclosure contemplate that unmanned aircraft consume large amounts of power while flying. The flight engines of such unmanned aircraft often require large amounts of power just to remain in the air. Embodiments of the disclosure also contemplate that unmanned aircraft are increasingly being used for high-altitude surveillance and monitoring operations, which presents a problem: if the unmanned aircraft must monitor an environment or situation from an elevated position, the power consumed by the flight engine can limit the amount of time during which this monitoring operation can continue to occur. While some energy can be harvested from passive charging devices such as photovoltaic cells, the amount of energy generated is generally insufficient to keep up with the amount consumed by propellers and other flight components.

Embodiments of the disclosure solve this problem by providing methods and systems for an unmanned aircraft to selectively attach an unmanned aircraft suspension perch to a surface at an attachment location. Thereafter, the unmanned aircraft can mechanically attach itself to the perch and can reduce a lift force generated by the flight engine, thereby causing the unmanned aircraft to suspend from the unmanned aircraft suspension perch.

In one or more embodiments, a method of attaching an unmanned aircraft suspension perch to a surface with an unmanned aircraft includes retrieving, with the unmanned aircraft, the unmanned aircraft suspension perch from an unmanned aircraft suspension perch storage area. One or more processors of the unmanned aircraft can select an attachment location for the unmanned aircraft suspension perch. A flight engine responsive to the one or more processors can navigate the unmanned aircraft to the attachment location. The unmanned aircraft can then attach the unmanned aircraft suspension perch to the surface at the attachment location. The perch interface of the unmanned aircraft can then release the unmanned aircraft suspension perch while the unmanned aircraft suspension perch remains attached to the surface at the attachment location. Thereafter, as needed, the unmanned aircraft can again navigate to the attachment location and attach the unmanned aircraft to the unmanned aircraft suspension perch for suspension from the surface.

In one or more embodiments, while being suspended from the unmanned aircraft suspension perch, one or more processors of the unmanned aircraft can further turn the flight engine OFF. For example, when both a perch connector of an unmanned aircraft suspension perch is coupled to a surface at the attachment location, and a perch interface of the unmanned aircraft is coupled to the unmanned aircraft suspension perch, the one or more processors can cause the delivery of power to the flight engine to cease, thereby causing the unmanned aircraft to suspend from the surface via the unmanned aircraft suspension perch. When this occurs, the unmanned aircraft can continue its mission or monitoring operation. However, the unmanned aircraft will consume far less power due to the flight engine being turned OFF, thereby extending the amount of time during which this monitoring operation can continue to occur.

In one or more embodiments, an unmanned aircraft includes a housing. The housing includes a perch interface configured to selectively couple to and unmanned aircraft suspension perch. For example, the perch interface can be equipped with mechanical hooks, latches, grabbers, or other mechanical coupling devices that are controllable by one or more processors. When the one or more processors cause the unmanned aircraft to abut or engage the unmanned aircraft suspension perch, the one or more processors can cause the mechanical coupling devices to latch on to the unmanned aircraft suspension perch, thereby coupling the unmanned aircraft to the unmanned aircraft suspension perch. In other embodiments, the perch interface can include adhesive couplers, suction cup couplers, hook and loop fastener couplers, or magnetic couplers suitable for coupling the unmanned aircraft to the unmanned aircraft suspension perch. Other types of perch interfaces suitable for coupling to the unmanned aircraft suspension perch will be obvious to those of ordinary skill in the art having the benefit of this disclosure.

In one or more embodiments, the unmanned aircraft suspension perch is selectively attachable to the perch interface such that it can be attached to, and detatched from, the perch interface. In one or more embodiments, the unmanned aircraft suspension perch also includes a perch connector that is suitable for coupling to a surface or other object. Examples of perch connectors include hooks, electromagnets, and controllable suction cups. Other examples of perch connectors include adhesive couplers, passive suction cups, conventional magnets, and hook and loop fasteners. Other types of perch connectors suitable for coupling the unmanned aircraft suspension perch to a surface or other object will be obvious to those of ordinary skill in the art having the benefit of this disclosure. In one or more embodiments, the perch connector is configured to have a greater retention force, when coupled to a surface, than the perch interface, when coupling the unmanned aircraft suspension perch to the unmanned aircraft.

In one or more embodiments, the unmanned aircraft also includes a flight engine coupled to the housing. One or more processors can then be operable with the flight engine, such as to turn it ON, turn it OFF, cause the unmanned aircraft to rise, cause the unmanned aircraft to descend, and so forth. In one or more embodiments, the one or more processors cause the flight engine to navigate the unmanned aircraft to an attachment location. The one or more processors can then cause the flight engine to cause the perch connector to couple to a surface at the attachment location. Thereafter, the one or more processors can cause the perch interface to release the unmanned aircraft suspension perch from the perch interface while the unmanned aircraft suspension perch remains attached to the surface at the attachment location.

In one or more embodiments, the unmanned aircraft can move an unmanned aircraft suspension perch from one location to another. For example, the one or more processors can cause the flight engine to navigate the unmanned aircraft to an attachment location where a previously installed unmanned aircraft suspension perch is coupled to a surface. The one or more processors can then cause the perch interface to couple to the unmanned aircraft suspension perch. The one or more processors can then cause the perch connector to release from the surface at the attachment location. From there, the unmanned aircraft suspension perch can be taken to another attachment location or to an unmanned aircraft suspension perch storage area.

In one or more embodiments, the one or more processors of the unmanned aircraft can select a type of perch based upon a mission, task, or location from which a mission or task is to be completed. For instance, where multiple unmanned aircraft suspension perches are stored at an unmanned aircraft suspension perch storage area, the one or more processors can cause the unmanned aircraft to attach to a particular unmanned aircraft suspension perch based upon a job. Similarly, where a unmanned aircraft suspension perch is initially attached to the unmanned aircraft and it is unsuited for coupling to a particular surface, the one or more processors can cause the unmanned aircraft to return that unmanned aircraft suspension perch to an unmanned aircraft suspension perch storage area, retrieve another unmanned aircraft suspension perch, and take it back for attachment to a surface at the attachment location.

Illustrating by example, if an unmanned aircraft initially has a unmanned aircraft suspension perch having an electromagnet in its perch connector, and has a mission, job, or task that needs to take place in a room with a ceiling fan, the one or more processors may identify that an unmanned aircraft suspension perch having a hook as its perch connector would be better suited for its mission as the hook can simply hang onto a blade of the ceiling fan. Where this occurs, the one or more processors can cause the unmanned aircraft to switch unmanned aircraft suspension perches so that a more suitable one can be used.

In another embodiment, the one or more processors can select an attachment location for the unmanned aircraft suspension perch based on one or more criteria. Illustrating by example, in one or more embodiments the unmanned aircraft is equipped with photovoltaic cells for light-based energy capture and charging of its energy storage device. Where this is the case, the one or more processors may select an attachment location to maximize received light at the photovoltaic cells to maximize charging. For instance, if a job, mission, or task is occurring in a room having a ceiling fan with a light suspended therefrom, suspension of an unmanned aircraft having photovoltaic cells across the top of its housing from a ceiling would cause the photovoltaic cells to receive less light than if the unmanned aircraft suspended itself from the fan itself with the photovoltaic cells situated directly beneath the light. Thus, the one or more processors might cause the unmanned aircraft to select an unmanned aircraft suspension perch with a hook as the perch connector rather than an electromagnet or other type of perch connector.

Thus, in one or more embodiments, a method of attaching an unmanned aircraft suspension perch to a surface with an unmanned aircraft includes first identifying, with one or more processors, a perch type of a first unmanned aircraft suspension perch initially coupled to the unmanned aircraft. The one or more processors can then optionally select an attachment location that includes the surface. As noted, in one or more embodiments this attachment location can be selected by determining, with the one or more sensors, where light reception by the one or more photovoltaic cells will be optimized.

In one or more embodiments, the one or more processors can then determine whether the first unmanned aircraft suspension perch is configured or optimal for couple to the surface at the attachment location. Where the first unmanned aircraft suspension perch is configured to couple to the surface, the unmanned aircraft can navigate, with a flight engine responsive to the one or more processors, the unmanned aircraft to the attachment location and attach the first unmanned aircraft suspension perch to the surface at the attachment location. By contrast, where the first unmanned aircraft suspension perch is unsuited for coupling to the surface, the unmanned aircraft can return the first unmanned aircraft suspension perch to an unmanned aircraft suspension perch storage area. The unmanned aircraft can then retrieve a second unmanned aircraft suspension perch, navigate to the attachment location, and attach the second unmanned aircraft suspension perch to the surface at the attachment location.

Advantageously, embodiments of the disclosure provide methods and systems for an unmanned aircraft or drone to selectively install, and uninstall, an unmanned aircraft suspension perch to a surface. The drone can select which unmanned aircraft suspension perch to install and where to install the unmanned aircraft suspension perch based upon criteria such as mission to be completed, task to be done, optimal hiding or “out of visibility” location, or even to optimize photovoltaic cell charging. Since power consumption for unmanned aircraft is a limitation in prior art systems, the ability to perch and/or recharge based on use case requirements is advantageous in that it reduces overall power consumption and allows the unmanned aircraft to work for longer periods of time between recharging cycles. Moreover, the ability to identify an install location for a perching site and conducting the installation eliminates the need for a user to manually install perches at various locations.

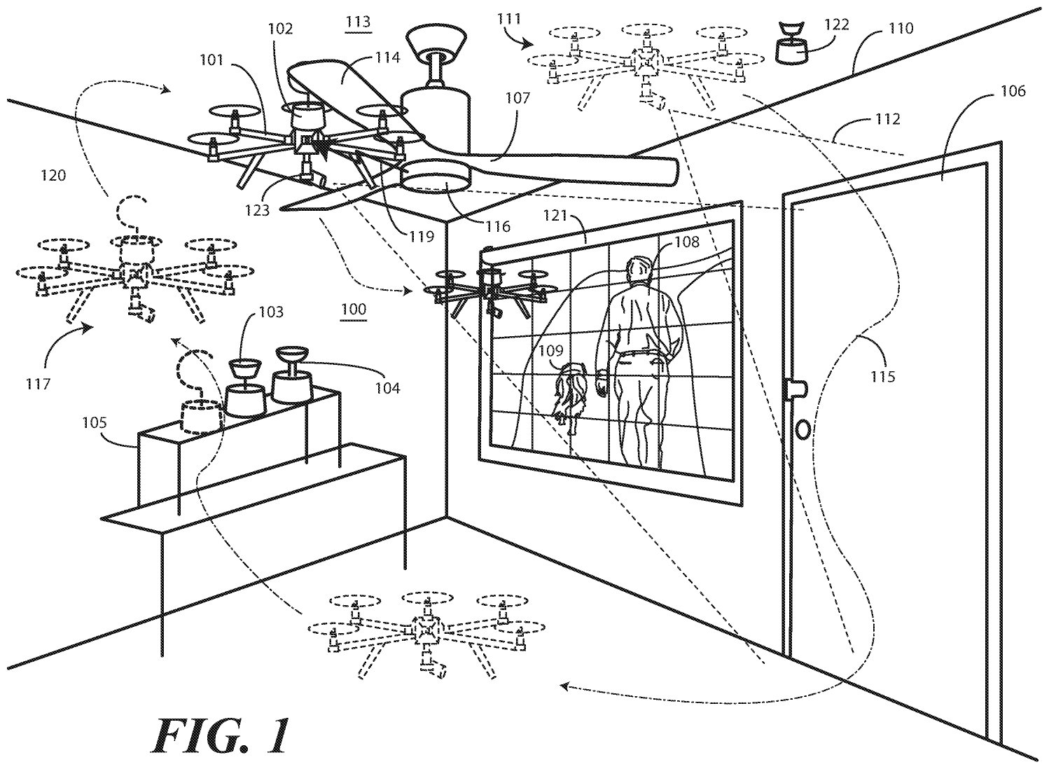

Turning now to FIG. 1, illustrated therein is one explanatory environment 100 in which systems and methods in accordance with one or more embodiments of the disclosure can be implemented. In this illustrative example, a person 108 and his dog 109, Buster, are leaving the home 110 to go for a walk.

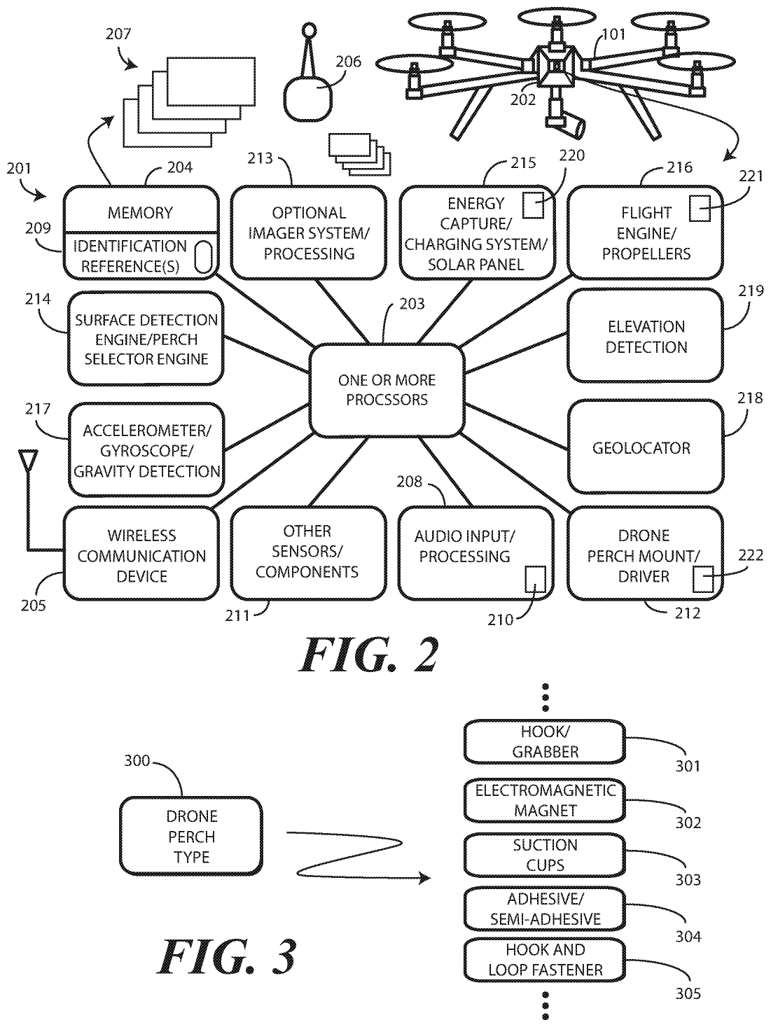

In one or more embodiments, the unmanned aircraft 101 is equipped with one or more sensors. Examples of such sensors will be described below with reference to FIG. 2. However, in one embodiment the sensors comprise an image capture device 123. An audio capture device can be included as well. In one or more embodiments, the unmanned aircraft 101 also carries one or more processors (shown below in FIG. 2) that are operable with the image capture device 123 and other sensors coupled to or integrated in the housing of the unmanned aircraft.

As noted above, the one or more processors can be operable with a memory storing unique stored program instructions that control the one or more processors to implement, in conjunction with certain non-processor circuits, some, most, or all of the functions of controlling the unmanned aircraft 101. In the illustrative embodiment of FIG. 1, person 108 has programmed an unmanned aircraft 101 to monitor 112 the front door 106 to ensure that no intruder enters. To remain in a stealth mode of monitoring, the person 108 desires the unmanned aircraft 101 to monitor 112 from an elevated position near the ceiling 113. This way, if an intruder does enter, they may not see the unmanned aircraft 101, thereby allowing the image capture device 123 to capture successive images or video of the intruder for delivery to the proper authorities.

A prior art drone so programmed might hover at an elevated location 111 near the door to perform the monitoring operation. However, as noted above, this would require the drone to consume large amounts of power while hovering, thereby limiting the amount of time the monitoring operation could occur. Periodically, the drone would need to return to a charging station to recharge. If an intruder entered the home while recharging, they may steal all of the person's stuff without the drone being able to capture images of the intruder. This would be tragic and would defeat the purpose of having a drone in the first place.

Advantageously, the unmanned aircraft 101 of FIG. 1 is configured in accordance with one or more embodiments of the disclosure. The unmanned aircraft 101 includes one or more processors configured to execute a method of attaching an unmanned aircraft suspension perch 102 to a surface with an unmanned aircraft 101.

As shown in FIG. 1, the unmanned aircraft 101 navigates along a flight path 115 to an unmanned aircraft suspension perch storage area 105. While a remote operator could navigate the unmanned aircraft along the flight path 115 with a control device, in one or more embodiments one or more processors of the unmanned aircraft 101 are configured to autonomously navigate the unmanned aircraft 101 along the flight path 115. The one or more processors could be equipped with, or responsive to, an artificial intelligence system (which can be remote) that controls the unmanned aircraft 101. Other sources of remotely controlling the unmanned aircraft 101 will be obvious to those of ordinary skill in the art having the benefit of this disclosure.

In this illustrative embodiment, the unmanned aircraft suspension perch storage area 105 includes three unmanned aircraft suspension perches: a first unmanned aircraft suspension perch 102 equipped with a hook, a second unmanned aircraft suspension perch 103 equipped with an electromagnet, and a third unmanned aircraft suspension perch 104 equipped with a controllable suction cup.

In this illustration, the image capture device 123 of the unmanned aircraft 101, working in conjunction with the one or more processors, determines that there is a ceiling fan 107 in the middle of the room. Additionally, the image capture device 123 determines that there is a light 116 at the base of the ceiling fan 107.

In one or more embodiments, the one or more processors of the unmanned aircraft 101 are configured to select an unmanned aircraft suspension perch based upon a surface to which the unmanned aircraft suspension perch will be attached. In this illustration, the unmanned aircraft 101 is equipped with one or more photovoltaic cells along its housing. Accordingly, while the unmanned aircraft 101 could use the third unmanned aircraft suspension perch 104 equipped with a controllable suction cup to suspend itself from the ceiling 113, the one or more processors instead select the first unmanned aircraft suspension perch 102 equipped with the hook. The unmanned aircraft 101 then retrieves 117 first unmanned aircraft suspension perch 102 equipped with the hook from the unmanned aircraft suspension perch storage area 105 and continues on the flight path 115.

In one or more embodiments, the one or more processors of the unmanned aircraft 101 then select an attachment location 118 for the unmanned aircraft suspension perch 102. This selection can be a function of one or more criteria. For example, the selection of the attachment location 118 could be based upon the task at hand. In this example, the task is monitoring the front door 106. Thus, the one or more processors might select an attachment location 118 where the front door 106 is most visible to the image capture device 123.

In one embodiment where the unmanned aircraft is equipped with photovoltaic cells, the selection of the attachment location 118 for the unmanned aircraft suspension perch 102 includes determining, with one or more sensors of the unmanned aircraft, a location where ambient light 119 received by one or more photovoltaic cells coupled to the unmanned aircraft is optimized, e.g., where light reception is maximized within the environment 100. Here, the attachment location 118 is along a fan blade 114 of the ceiling fan 107 where light 119 from the light 116 of the ceiling fan 107 shines directly into the photovoltaic cells.

After selecting this attachment location, a flight engine of the unmanned aircraft 101 that is operable with the one or more processors navigates 120 the unmanned aircraft 101 to the attachment location 118. The unmanned aircraft 101 then attaches the unmanned aircraft suspension perch 102 to the surface at the attachment location 118. In this example, this occurs when the unmanned aircraft 101 causes the hook to engage the fan blade 114. From this position, the image capture device 123 can continue to monitor the front door 106.

Since the unmanned aircraft 101 is now suspended from the fan blade 114, the flight engine is no longer needed to make the unmanned aircraft 101 hover. Accordingly, the one or more processors can turn the flight engine OFF when both the perch connector, here the hook, is coupled to the surface at the attachment location 118 and the perch interface of the unmanned aircraft 101 is coupled to the unmanned aircraft suspension perch 102. This causes the unmanned aircraft 101 to suspend from the surface via the unmanned aircraft suspension perch 102. Thus, power consumption by the unmanned aircraft 101 is dramatically reduced, thereby extending the time that the image capture device 123 can continue to monitor the front door 106 between recharging cycles.

In one or more embodiments, the unmanned aircraft 101 can leave the unmanned aircraft suspension perch 102 attached to the surface at the attachment location 118 for future use. In the illustrative embodiment of FIG. 1, unmanned aircraft suspension perch 122 has been left attached to the ceiling 113 as an example. Additionally, in one or more embodiments a perch interface of the unmanned aircraft 101 can release the unmanned aircraft suspension perch 102 while the unmanned aircraft suspension perch 102 remains attached to the surface at the attachment location 118. This may be necessary, for example, when the unmanned aircraft 101 is called to do another task or needs recharging.

Then, at a later time, the unmanned aircraft 101 can again navigate 120 to the attachment location 118 and attach itself to the unmanned aircraft suspension perch 102. When this occurs, the one or more processors can cause the flight engine to reduce a lift force generated by the flight engine, thereby causing the unmanned aircraft 101 to suspend from the unmanned aircraft suspension perch 102.

In one or more embodiments, the unmanned aircraft 101 can also move the unmanned aircraft suspension perch 102 to another location, or alternatively return it to its unmanned aircraft suspension perch storage area 105. For example, the unmanned aircraft 101 can connect to the unmanned aircraft suspension perch 102 with the perch interface, and can then cause the unmanned aircraft suspension perch 102 to release from the surface at the attachment location 118. The one or more processors can then select another attachment location for the unmanned aircraft suspension perch 102 and can navigate, with the flight engine, the unmanned aircraft 101 to the other attachment location. The unmanned aircraft 101 can then attach the unmanned aircraft suspension perch 102 to another surface at the other attachment location, and can release the unmanned aircraft suspension perch 102 while the unmanned aircraft suspension perch 102 remains attached to the other surface at the other attachment location, and so forth.

For example, the steps of retrieving the unmanned aircraft suspension perch 102 from the unmanned aircraft suspension perch storage area 105, navigating 120 to the attachment location 118, and attaching the unmanned aircraft suspension perch 102 to the fan blade 114 at the attachment location 118 could be reversed to return the unmanned aircraft suspension perch 102 to the unmanned aircraft suspension perch storage area 105. Alternatively, if the light 116 of the ceiling fan 107 burns out or otherwise turns OFF, the one or more processors may determine that attaching to a windowsill 121 would better optimize photovoltaic charging. Thus, the one or more processors can select the windowsill 121 as another attachment location for the unmanned aircraft suspension perch 102, navigate, with the flight engine, the unmanned aircraft 101 to the windowsill 121 and attach the unmanned aircraft suspension perch 102 to windowsill 121 for either additional monitoring of the front door or to release the unmanned aircraft suspension perch 102 while the unmanned aircraft suspension perch 102 remains attached to the windowsill 121.

Turning now to FIG. 2, illustrated therein is one explanatory unmanned aircraft 101 configured in accordance with one or more embodiments of the disclosure. An explanatory block diagram schematic 201 is also shown in FIG. 2. The block diagram schematic 201 can be configured as a printed circuit board assembly disposed within a housing 202 of the unmanned aircraft 101. Various components can be electrically coupled together by conductors or a bus disposed along one or more printed circuit boards.

The illustrative block diagram schematic 201 of FIG. 2 includes many different components. Embodiments of the disclosure contemplate that the number and arrangement of such components can change depending on the particular application. Accordingly, drones and unmanned aerial vehicles configured in accordance with embodiments of the disclosure can include some components that are not shown in FIG. 2, and other components that are shown may not be needed and can therefore be omitted.

In one embodiment, the unmanned aircraft 101 includes one or more processors 203. The one or more processors 203 can include a microprocessor, a group of processing components, one or more ASICs, programmable logic, or other type of processing device. The one or more processors 203 can be operable with the various components of the block diagram schematic 201. The one or more processors 203 can be configured to process and execute executable software code to perform the various functions of the unmanned aircraft 101 with which the block diagram schematic 201 operates. A storage device, such as memory 204, can optionally store the executable software code used by the one or more processors 203 during operation.

In this illustrative embodiment, the block diagram schematic 201 also includes a wireless communication device 205 that can be configured for wireless communication with a control device 206, which may be controlled by an operator or controlled by a machine. The wireless communication device 205 can alternatively communicate with one or more remote devices. The wireless communication device 205 may utilize wireless technology for communication, such as, but are not limited to, peer-to-peer or ad hoc communications, as well as other forms of wireless communication. The wireless communication device 205 can include wireless communication circuitry, one of a receiver, a transmitter, or transceiver, and one or more antennas.

In one embodiment, the one or more processors 203 can be responsible for performing the primary functions of the unmanned aircraft 101 with which the block diagram schematic 201 is operational. The executable software code used by the one or more processors 203 can be configured as one or more modules 207, which can include a voice recognition engine, a facial recognition engine, or combinations thereof in one embodiment, and that are operable with the one or more processors 203. Such modules 207 can store instructions, control algorithms, and so forth.

In one or more embodiments, the block diagram schematic 201 includes an optional audio processing engine 208, which functions in coordination with the one or more processors 203 in one or more embodiments. In one or more embodiments, the audio processing engine 208 is capable of receiving audio input, processing audio input, extracting one or more audio characteristics from received audio input, storing one or more voice prints or the extracted audio characteristics as identification references 209 in the memory 204, and performing other functions. For example, in one or more embodiments the audio processing engine 208 is operable to receive audio input from an environment about the unmanned aircraft 101.

The audio processing engine 208 can include hardware, executable code, and speech monitoring and generation executable code in one embodiment. The audio processing engine 208 can be operable with one or more identification references 209 stored in memory 204. These identification references 209 can include audio characteristics extracted from received audio input, voice prints, audio identification models, or other data structures suitable for use by the one or more processors 203 to uniquely identify received voice input.

The audio processing engine 208 can be operable with one or more microphones 210. Illustrating by example, a first microphone can be located on a first side of the unmanned aircraft 101 for receiving audio input from a first direction, while a second microphone can be placed on a second side of the unmanned aircraft 101 for receiving audio input from a second direction.

In one embodiment, the audio processing engine 208 is configured to implement a voice control feature that allows a user to speak a specific device command to cause the one or more processors 203 to execute a control operation. In one embodiment the audio processing engine 208 listens for voice commands, processes the commands and, in conjunction with the one or more processors 203, initiates actions or processes in response to the commands.

Other sensors and components 211 can be operable with the one or more processors 203. General examples of the sensors included with the other sensors and components 211 include time sensors, environmental sensors, weather sensors, location sensors, and so forth. These sensors or components 211 can be used alone or in various combinations. These other sensors and components 211 can include light sensors, magnetometers, laser measuring devices, and so forth. The other sensors and components 211 can include input and output components, such as power inputs and outputs and/or mechanical inputs and outputs. Still other components will be obvious to those of ordinary skill in the art having the benefit of this disclosure.

A temperature sensor can be configured to monitor the temperature of the environment about the unmanned aircraft 101. A light sensor can be used to detect whether or not ambient light is incident on the housing 202 of the unmanned aircraft 101. Other examples of sensors will be obvious to those of ordinary skill in the art having the benefit of this disclosure.

The other sensors and components 211 can also include a motion sensor, which can include one or more accelerometers or gyroscopes. In one embodiment the motion sensors are operable to detect movement, and direction of movement, of the unmanned aircraft 101. The motion sensors can optionally be configured as an orientation detector that determines an orientation and/or movement of the unmanned aircraft 101 in three-dimensional space. The orientation detector can determine the spatial orientation of an unmanned aircraft 101 in three-dimensional space by, for example, detecting a gravitational direction. The other sensors and components 211 can also be radio frequency receivers receiving beacon transmissions from remote devices as well.

The unmanned aircraft 101 can optionally include an imaging system 213. The imaging system 213 can include an imager such as the image capture device (123) shown in FIG. 1. In one embodiment, the imager comprises a two-dimensional imager configured to receive at least one image of an environment (100) of the unmanned aircraft 101. In one embodiment, the imager comprises a two-dimensional Red-Green-Blue (RGB) imager. In another embodiment, the imager comprises an infrared imager. Other types of imagers will be obvious to those of ordinary skill in the art having the benefit of this disclosure.

The imaging system 213 can also optionally include a depth scanner. Where included, the depth scanner can take a variety of forms. In a first embodiment, the depth scanner comprises a pair of imagers separated by a predetermined distance, such as three to four images. This “stereo” imager works in the same way the human eyes do in that it captures images from two different angles and reconciles the two to determine distance.

In another embodiment, the depth scanner employs a structured light laser. The structured light laser projects tiny light patterns that expand with distance. These patterns project on a surface, such as a user's face, and are then captured by an imager. By determining the size and spacing between the elements of the pattern, three-dimensional mapping can be obtained.

In still another embodiment, the depth scanner comprises a time of flight device. Time of flight three-dimensional sensors include a laser that emits laser light, with a photodiode array receiving reflected light. These pulses reflect back from a surface, such as the user's face. The time it takes for pulses to move from the photodiode array to the surface and back determines distance, from which a three-dimensional mapping of a surface can be obtained. Where included, the depth scanner adds a third “z-dimension” to the x-dimension and y-dimension defining the two-dimensional image captured by the imager of the imaging system 213.

Other components can be operable with the one or more processors 203, and can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker or other alarms and/or buzzers.

A surface detection and perch selector engine 214 can then operable with the various sensors to detect at type of surface to which an unmanned aircraft suspension perch will be attached. When the type of surface is detected, the surface detection and perch selector engine 214 can select an appropriate type of unmanned aircraft suspension perch should be used to couple to this surface. The surface detection and perch selector engine 214 can infer, capture, and otherwise determine objects and surfaces occurring in an environment (100) about the unmanned aircraft 101. For example, the surface detection and perch selector engine 214 can assess contexts and frameworks using adjustable algorithms of context assessment employing information, data, and events. These assessments may be learned through repetitive data analysis. The surface detection and perch selector engine 214 can comprise an artificial neural network or other similar technology in one or more embodiments.

Illustrating by example, in the illustrative example of FIG. 1, a ceiling fan (107) was hanging in the middle of the room. In one or more embodiments, the surface detection and perch selector engine 214 can determine whether the ceiling fan (107) is manufactured from metal. Where this is the case, the surface detection and perch selector engine 214 may select an unmanned aircraft suspension perch (103) that employs an electromagnetic coupler. However, the surface detection and perch selector engine 214 can make the selection based upon other information as well. Recall from FIG. 1 that the ceiling fan (107) also included a light (116). By analyzing the light (119) emitted from the light (116), the surface detection and perch selector engine 214 determined that the unmanned aircraft suspension perch (102) employing the hook perch connector was a better choice because suspending the unmanned aircraft 101 from the fan blade (114) optimized the receipt of light by the photovoltaic cells included with the energy capture and charging system 215.

In one or more embodiments, the surface detection and perch selector engine 214 is operable with the one or more processors 203. In some embodiments, the one or more processors 203 can control the surface detection and perch selector engine 214. In other embodiments, the surface detection and perch selector engine 214 can operate independently, delivering information gleaned from detecting environmental clues, environmental object and machine states, and other contextual information to the one or more processors 203. The surface detection and perch selector engine 214 can receive data from the various sensors. In one or more embodiments, the one or more processors 203 are configured to perform the operations of the surface detection and perch selector engine 214.

The unmanned aircraft 101 can also include an energy capture and charging system 215. The energy capture and charging system 215 can include one or more photovoltaic cells that receive ambient light from the environment about the unmanned aircraft 101. In addition to selecting the type of unmanned aircraft suspension perch to be used, in one or more embodiments the surface detection and perch selector engine 214 can be operable with the energy capture and charging system 215 to select an appropriate location for the unmanned aircraft suspension perch to be located as a function of where the energy capture and charging system 215 is able to deliver a maximum charging current to the energy storage devices 221, which may be lithium-ion or lithium-polymer cells in one embodiment. In one or more embodiments, the surface detection and perch selector engine 214 can be operable with the energy capture and charging system 215 to select an appropriate location for the unmanned aircraft suspension perch to be located as a function of where the photovoltaic cells 220 receive a maximum amount of light from the environment about the unmanned aircraft 101.

The unmanned aircraft 101 can further include a flight engine 216. In one embodiment, the flight engine 216 can include one or more rotary wings. Illustrating by example, the flight engine 216 can include four, six, or eight or more rotors configured as propellers. These propellers can be movable between a generally downward oriented direction to directions tilting forward, aft, and side-to-side so as to move the unmanned aircraft 101 up and down and side to side as desired.

In another embodiment, the flight engine 216 can include an air storage bladder, similar to that used in a blimp. Warm air or buoyant gas can be stored in the bladder to give the unmanned aircraft 101 lift. Releasing the buoyant gas or cooling the air can cause the unmanned aircraft 101 to sink. Of course, combinations of rotary wings and the air storage bladder can be used as well.

An operator or “pilot,” which may be an automated computer system, can use the control device 206 to control the flight engine 216 to move the unmanned aircraft 101 as desired in one or more embodiments. In other embodiments, one or more firmware modules 207 can be stored in the memory 204 so that the unmanned aircraft 101 can perform flight operations and can fly flight patterns autonomously. Of course, a combination of control through the control device 206 and autonomous flight action can also be implemented.

In one or more embodiments, the flight engine 216 can include an energy storage device, such as a lithium-ion or lithium-polymer battery, that selectively propels the rotary wings or propellers in response to control signals from the one or more processors 203. Each propeller can be a two, three, four, or more bladed assembly. Increasing propeller blades decreases noise and increases thrust, while decreasing propeller blades increases efficiency. The exact number of blades or propellers can be selected based upon design, geographic location, typical wind and weather conditions, and so forth. The one or more processors 203 can deliver control signals to the flight engine 216 to adjust and change the speeds of each motor driving each propeller to control the speed, direction, and motion of the unmanned aircraft 101.

In one or more embodiments, the unmanned aircraft 101 includes one or more orientation sensors 217, such as one or more accelerometers, gyroscopes, gravity detectors, or other devices that can determine the azimuth, plumb, and tilt of the unmanned aircraft 101 when in operation. For example, an accelerometer may be used to show vertical orientation, constant tilt and/or whether the unmanned aircraft 101 is stationary or in motion. A gyroscope can be used in a similar fashion. In addition to, or instead of, an accelerometer and/or gyroscope, an electronic compass can be included to detect the spatial orientation of the unmanned aircraft 101 relative to the earth's magnetic field.

The orientation sensors 217 can be used to determine the spatial orientation of the unmanned aircraft 101 when in operation as well. In one embodiment, the one or more orientation sensors 217 make such determinations by detecting a gravitational direction. A geolocator 218 can determine a latitude and longitude coordinate location for the unmanned aircraft 101. In one embodiment, geolocator 218 comprises a Global Positioning System (GPS) device that determines latitudinal and longitudinal coordinates from a constellation of one or more earth orbiting satellites or from a network of terrestrial base stations. Other systems can be used in place of the GPS system, such as the Global Orbiting Navigation System (GLONASS) or other satellite positioning systems. The geolocator 218 may also be able to determine location of the unmanned aircraft 101 by locating or triangulating terrestrial base stations of a traditional cellular network or from other local area networks.

An elevation detector 219, such as an altimeter, can be included to determine an altitude of the unmanned aircraft 101 while in operation. Other components could be included as well, as the unmanned aircraft 101 of FIG. 1 is illustrative only. Numerous other configurations will be obvious to those of ordinary skill in the art having the benefit of this disclosure.

To couple the unmanned aircraft 101 to an unmanned aircraft suspension perch, a perch interface 212 can be included. The perch interface 212 can include a surface configured to support an unmanned aircraft suspension perch. As will be described below, the perch interface 313 can include one of an adhesive coupling, a suction coupling, a hook and loop fastener coupling, a latch, or a magnetic coupling.

The perch interface 212 can include mechanical features configured to latch on to, and release, the unmanned aircraft suspension perch so that the unmanned aircraft suspension perch can be attached to the unmanned aircraft 101, detached from the unmanned aircraft 101, and moved by the unmanned aircraft 101. The perch interface 212 can include one or more mechanical features, such as hooks, latches, adhesives, hook and loop fasteners, magnets, or other features that selectively couple the unmanned aircraft suspension perch to the unmanned aircraft 101.

These mechanical features can be passive or active. For example, where the mechanical feature comprises an adhesive or hook and loop fastener, these comprise passive coupling devices for the perch interface 212. To couple the perch interface 212 to an unmanned aircraft suspension perch, the unmanned aircraft 101 causes the perch interface 212 to abut, and put pressure against, the unmanned aircraft suspension perch. This applied force causes the unmanned aircraft suspension perch to be mechanically retained coupled to the perch interface 212. Where the perch interface 212 includes a passive mechanical feature for unmanned aircraft suspension perch retention, in one or more embodiments the passive mechanical feature has a lesser retention force than does the retention force with which the unmanned aircraft suspension perch is retained to the surface to which it is attached. The flight engine 216 can be used to provide a separation force to separate the unmanned aircraft 101 from an unmanned aircraft suspension perch when attached to a surface or being docked at an unmanned aircraft suspension perch storage area, for example.

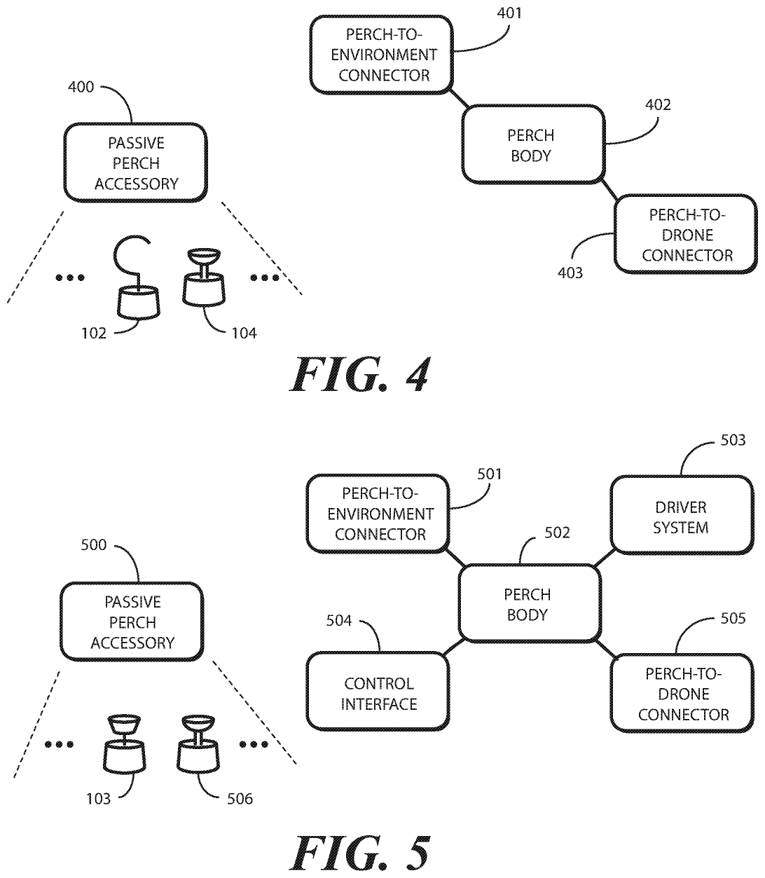

In other embodiments, the mechanical features are active. For example, the perch interface 212 can include movable hooks that selectively engage receivers on the unmanned aircraft suspension perch to attach the same to the unmanned aircraft 101. In another embodiment, the perch interface 212 includes a controllable electromagnet where current can be changed to cause the electromagnet to be attracted to, or repelled from, the unmanned aircraft suspension perch. In still another embodiment, the perch interface 212 includes a controllable suction cup where the geometry of the suction cup can be changed, or alternatively air can be injected into or removed from the suction cup, to retain the unmanned aircraft suspension perch to the unmanned aircraft 101. Where the mechanical features are active, a perch driver 222 can actuate or deactuate the mechanical features to selectively attach or detach the unmanned aircraft suspension perch from the unmanned aircraft 101 as desired. The perch driver 222 can also be used to drive a perch connector of the unmanned aircraft suspension perch as well, as will be described in more detail below with reference to FIGS. 4-5.

As with the perch interface 212, the perch connector with which the unmanned aircraft suspension perch attaches to a surface can be passive or active. Turning briefly to FIG. 3, illustrated therein are some examples of types of unmanned aircraft suspension perches, as defined by their perch connectors, in accordance with one or more embodiments of the disclosure. Still other types of unmanned aircraft suspension perches and perch connectors will be obvious to those of ordinary skill in the art having the benefit of this disclosure.

In one embodiment, an unmanned aircraft suspension perch 300 has a perch connector 301 that is configured as a hook (passive) or a grabber (active). Recall from above that in the illustrative embodiment of FIG. 1, the perch connector 301 was a passive hook that could be used to engage a surface such as a fan blade (114) or a windowsill (121). In other embodiments, the perch connector 301 could be an active grabber, such as a pair of mechanical pincers that can open and close to grab objects and surfaces.

In another embodiment, the unmanned aircraft suspension perch 300 has a perch connector 302 configured as an electromagnetically controlled magnet. Where the unmanned aircraft suspension perch 300 is to be attached to a metal surface, an electromagnetically controlled magnet can be used. Current can be controlled to make the electromagnetically controlled magnet attract to a metal surface to attach the unmanned aircraft suspension perch 300 to the metal surface. The current can be reversed to make the electromagnetically controlled magnet repel the unmanned aircraft suspension perch 300 from the metal surface when being removed therefrom.

In another embodiment, the unmanned aircraft suspension perch 300 has a perch connector 303 configured as either an active or passive suction cup. In the passive version, the suction cup adheres to surfaces when mechanical pressure deforms the shape of the suction cup in one direction. When an opposite mechanical force deforms the suction cup in the opposite direction, the suction cup releases from the surface. In the active version, air can be injected into, or removed from, the suction cup to cause it to attach to, or detach from, the surface.

In another embodiment, the unmanned aircraft suspension perch 300 has a perch connector 304 configured as an adhesive. In one or more embodiments, the adhesive adheres to surfaces when mechanical pressure compresses the adhesive. When an opposite mechanical force pulls the adhesive in the opposite direction, the adhesive releases from the surface.

In another embodiment, the unmanned aircraft suspension perch 300 has a perch connector 305 configured as a hook and loop fastener. In one or more embodiments, the hook and loop fastener adheres to surfaces when mechanical pressure pushes either a hook fastener or a loop fastener into a complementary loop fastener or hook fastener mounted on the surface to which the unmanned aircraft suspension perch 300 is to be connected. When an opposite mechanical force separates the hook fastener or the loop fastener from the complementary loop fastener or hook fastener mounted on the surface, the unmanned aircraft suspension perch 300 releases from the surface.

It should be noted that the types of unmanned aircraft suspension perches 300 described in FIG. 3 are illustrative only. Numerous others will be obvious to those of ordinary skill in the art having the benefit of this disclosure.

Turning now to FIG. 4, illustrated therein is a schematic block diagram of a passive unmanned aircraft suspension perch 400 configured in accordance with one or more embodiments of the disclosure. Examples of passive unmanned aircraft suspension perches 400 include the unmanned aircraft suspension perch 102 having a hook as a perch connector or the unmanned aircraft suspension perch 104 having a passive suction cup as the perch connector.

As shown in FIG. 4, the passive unmanned aircraft suspension perch 400 includes the perch connector 401, a perch body 402, and a perch-to-drone connector 403. Examples of passive devices suitable for use as the perch connector 401 include a hook, adhesive, a hook fastener, a loop fastener, or a mechanical loop. The perch connector 401 is coupled to the perch body 402 in one or more embodiments. Where the perch connector 401 is passive, the perch-to-drone connector 403 could be active or passive. Examples of perch-to-drone connectors 403 include mechanical latches, adhesives, conventional magnets, and electromagnetically controllable magnets, hook fasteners, or loop fasteners.

Turning to FIG. 5, illustrated therein is a schematic block diagram of an active unmanned aircraft suspension perch 500 configured in accordance with one or more embodiments of the disclosure. Examples of active unmanned aircraft suspension perches 500 include the unmanned aircraft suspension perch 103 having an electromagnet as a perch connector or the unmanned aircraft suspension perch 506 having an active suction cup as the perch connector.

As shown in FIG. 5, the active unmanned aircraft suspension perch 500 includes the active perch connector 501, a perch body 502, and a perch-to-drone connector 505. Examples of active devices suitable for use as the active perch connector 501 include an electromagnet, active hook devices such as mechanical pincers, and active suction cups. Where an active perch connector 501 is includes, a driver system 503 can be included to selectively actuate the active perch connector 501. For example, where the active perch connector 501 is an electromagnet, the driver system 503 can selectively control current to make the active perch connector 501 selectively attract to, or repel from, a surface. Similarly, where the active perch connector 501 is an active suction cup, the driver system 503 can selectively inject air into, or remove air from, the active suction cup.

A control interface 504 serves as an intermediary between the driver system 503 and the perch driver (222) of the perch interface (212). The perch driver (222) can receive control signals from the one or more processors (203) directing the active perch connector 501 to attach to, or detach from, a surface. The perch driver (222) can then control the driver system 503 through the control interface 504 to cause the active perch connector 501 to attach to, or detach from, a surface, and so forth. The active perch connector 501 is coupled to the perch body 502 in one or more embodiments. The perch-to-drone connector 505 could be active or passive as previously described.

Turning now back to FIG. 2, in one or more embodiments, an unmanned aircraft suspension perch (300), which can be any of those described with reference to FIG. 3, is selectively attachable to the perch interface 212. As noted above, regardless of which type of unmanned aircraft suspension perch (300) is used, in one or more embodiments it includes a perch connector.

In one or more embodiments, the one or more processors 203 are operable to cause the flight engine 216 to navigate the unmanned aircraft 101 to an attachment location, which can be selected by the surface detection and perch selector engine 214. The one or more processors 203 then, either by controlling forces generated by the flight engine 216 or the perch driver 222, cause the perch connector to couple to a surface at the attachment location. Thereafter, the one or more processors 203 can cause, again by controlling forces generated by the flight engine 216 for passively coupled unmanned aircraft suspension perch interfaces or the perch driver 222 for active unmanned aircraft suspension perches, cause the perch interface 212 to release the unmanned aircraft suspension perch from the perch interface 212 while the unmanned aircraft suspension perch remains attached to the surface at the attachment location.

Where the energy capture and charging system 215 includes one or more photovoltaic cells 220, and the other sensors and components 211 include a light sensor or the energy capture and charging system 215 includes a charging sensor, the one or more processors 203, optionally in conjunction with the surface detection and perch selector engine 214, can determine where light reception by the one or more photovoltaic cells 220 will be optimized, and can cause the unmanned aircraft suspension perch to attach to a surface at this attachment location.

In one or more embodiments, the one or more processors 203 can cause the flight engine 216 to navigate to the attachment location. The one or more processors 203 can cause the flight engine 216 to cause the perch interface to mechanically engage the unmanned aircraft suspension perch. The one or more processors 203 can cause the perch connector to release the unmanned aircraft suspension perch from the surface at the attachment location.

In one or more embodiments, the one or more processors 203 are configured to turn the flight engine 216 OFF when both the perch connector is coupled to the surface at the attachment location and the perch interface 212 is coupled to the unmanned aircraft suspension perch. This allows the unmanned aircraft 10 to suspend from the surface via the unmanned aircraft suspension perch, as was shown in the illustrative example of FIG. 1 above where the unmanned aircraft 101 suspended itself from the ceiling fan (107) with the flight engine 216 turned OFF.

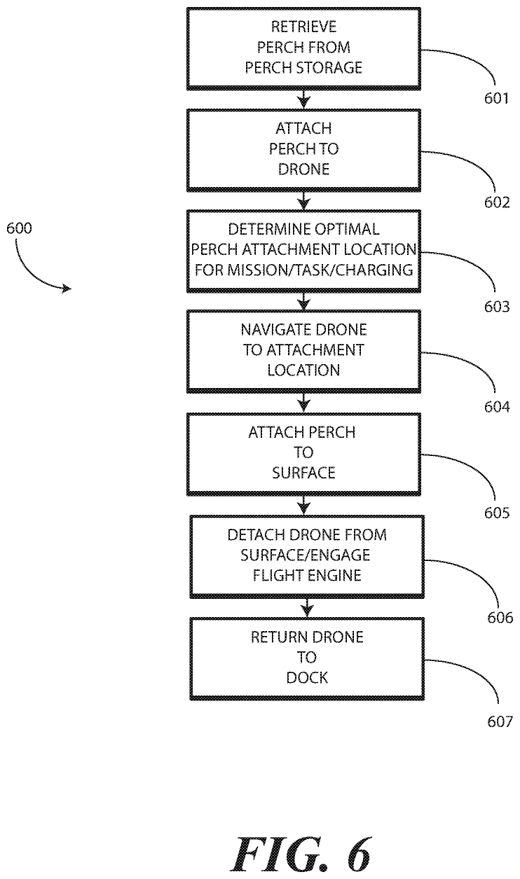

Turning now to FIG. 6, illustrated therein is one explanatory method 600 of attaching an unmanned aircraft suspension perch to a surface with an unmanned aircraft using the systems described above with reference to FIGS. 2-5. Beginning at step 601, the method 600 retrieves, with the unmanned aircraft, the unmanned aircraft suspension perch. In one or more embodiments, this step 601 can retrieve the unmanned aircraft suspension perch from an unmanned aircraft suspension perch storage area, such as that shown in FIG. 1. In another embodiment, this step 601 can retrieve the unmanned aircraft suspension perch from a surface to which it was previously attached and left by the unmanned aircraft. At step 602, the unmanned aircraft can attach the unmanned aircraft suspension perch to the perch interface as previously described.

At step 603, the method 600 can include selecting, with one or more processors carried by the unmanned aircraft, an attachment location for the unmanned aircraft suspension perch. IN one or more embodiments, step 603 includes determining, with one or more sensors of the unmanned aircraft, a location where ambient light received by one or more photovoltaic cells coupled to the unmanned aircraft is optimized.

At step 604, the method 600 includes navigating, with a flight engine responsive to the one or more processors, the unmanned aircraft to the attachment location. At step 605, the method attaches, with the unmanned aircraft, the unmanned aircraft suspension perch to the surface at the attachment location.

Step 605 can be performed in a number of ways. In one embodiment, step 605 comprises causing a hook of the unmanned aircraft suspension perch to engage the surface of the attachment location. In another embodiment, step 605 comprises causing a suction cup of the unmanned aircraft suspension perch to engage the surface of the attachment location. In still another embodiment, step 605 comprises causing an electromagnet to generate a magnetic field attracting the unmanned aircraft suspension perch to the surface of the attachment location. These options are illustrative only, as other techniques for causing the perch connector of the unmanned aircraft suspension perch to attach to the surface at the attachment location will be obvious to those of ordinary skill in the art having the benefit of this disclosure.

At step 606, the method 600 releases, with a perch interface of the unmanned aircraft, the unmanned aircraft suspension perch. In one or more embodiments step 605 occurs while the unmanned aircraft suspension perch remains attached to the surface at the attachment location. At step 607, the method 600 optionally includes navigating, with the flight engine responsive to the one or more processors, the unmanned aircraft to a dock or charging station. Thus, the method 600 of FIG. 6 provides steps in which an unmanned aircraft retrieves, and installs, and unmanned aircraft suspension perch to a surface at an attachment location.

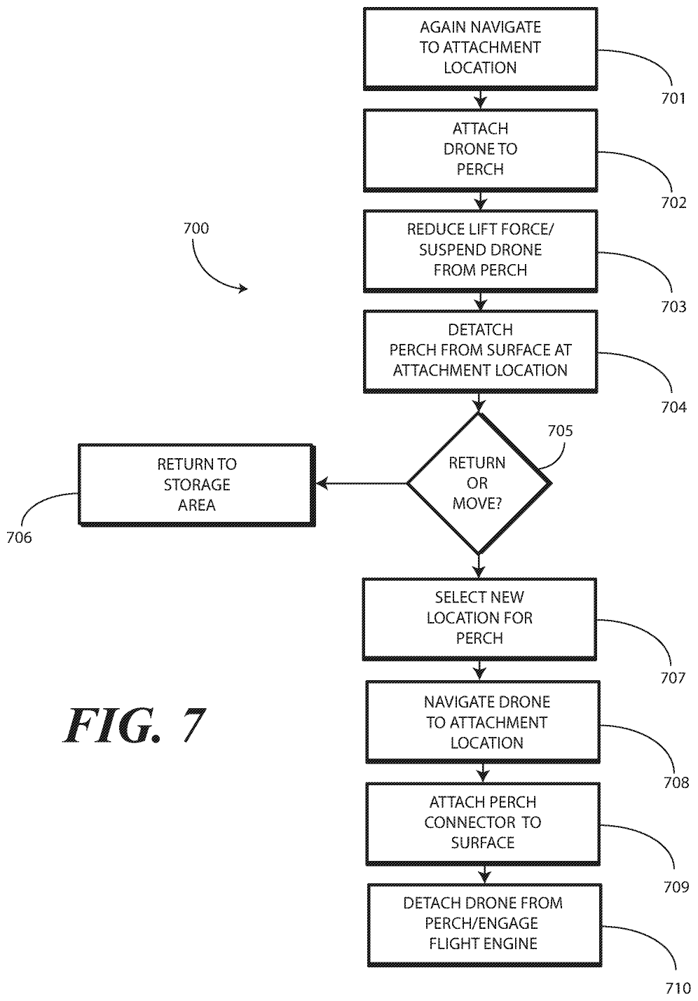

Turning now to FIG. 7, illustrated therein is another method 700 of utilizing the unmanned aircraft suspension perch installed using the method (600) of FIG. 6. Beginning at step 701, the method 700 again navigates the unmanned aircraft to the attachment location. At step 702, the method 700 attaches the unmanned aircraft to the unmanned aircraft suspension perch.

At step 703, the method 700 reduces a lift force generated by the flight engine. When this occurs, since the unmanned aircraft is attached to the unmanned aircraft suspension perch via the perch interface, and since the perch connector is coupled to the surface, it causes the unmanned aircraft to suspend from the unmanned aircraft suspension perch.

When the mission, task, or job is completed and the unmanned aircraft suspension perch needs to be removed from the surface, such as for return to a unmanned aircraft suspension perch storage area or so as to be moved and coupled to another surface at another attachment location, step 704 includes causing, with the perch interface, the unmanned aircraft suspension perch to release from the surface at the attachment location.

Decision 705 can determine whether the unmanned aircraft suspension perch us to be returned to the unmanned aircraft suspension perch storage area or deployed at another location. Where the former, step 706 includes returning the unmanned aircraft suspension perch to the unmanned aircraft suspension perch storage area.

Where the latter, step 707 includes selecting, with the one or more processors carried by the unmanned aircraft, another attachment location for the unmanned aircraft suspension perch. Step 708 includes navigating, with the flight engine, the unmanned aircraft to the other attachment location. Step 709 includes attaching, with the unmanned aircraft, the unmanned aircraft suspension perch to another surface at the other attachment location. Step 710 then includes releasing, with the perch interface of the unmanned aircraft, the unmanned aircraft suspension perch while the unmanned aircraft suspension perch remains attached to the other surface at the other attachment location.

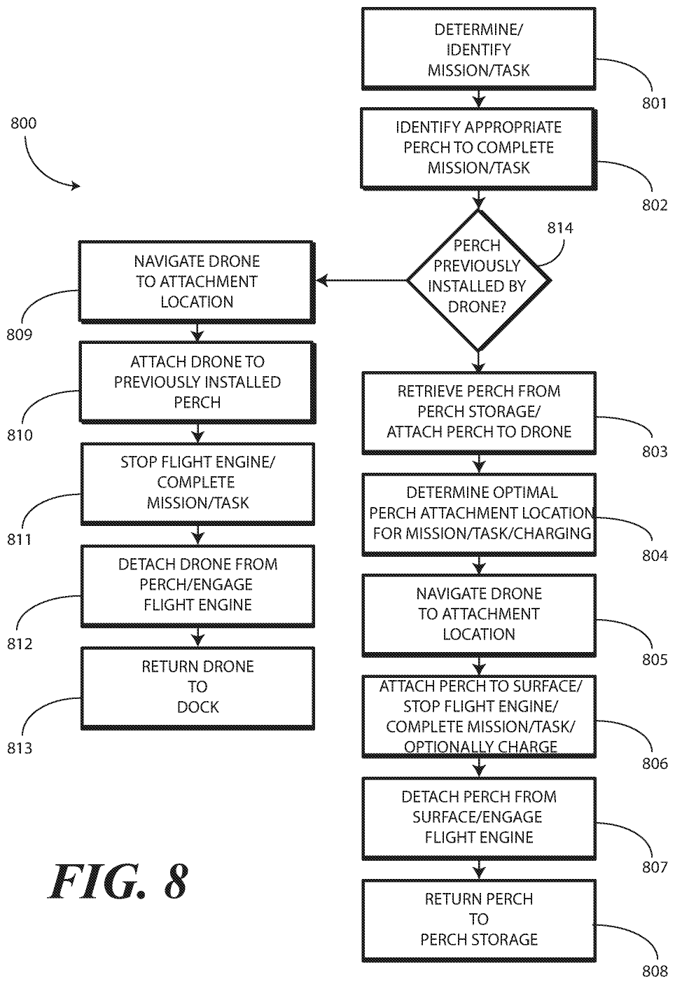

Turning now to FIG. 8, illustrated therein is yet another method 800 for of attaching an unmanned aircraft suspension perch to a surface with an unmanned aircraft in accordance with one or more embodiments of the disclosure. At step 801, the method 800 identifies a mission, task, or job to be performed by an unmanned aircraft. Illustrating by example, the mission of the example from FIG. 1 was monitoring (112) a door (106) while a person (108) and his dog (109) were out walking. Other examples of missions or tasks include monitoring people within a building, monitoring property from the air, and so forth.

At step 802, the method 800 identifies the appropriate unmanned aircraft suspension perch for the mission. If, for example, the mission is monitoring (112) a door (106) in the home (110), step 802 might select an unmanned aircraft suspension perch suitable for attachment to the ceiling (113) or the ceiling fan (107). By contrast, if the mission is to monitor a car in a driveway, step 802 might select an unmanned aircraft suspension perch suitable from hanging from a light post or tree branch, and so forth.

Decision 814 then identifies whether the unmanned aircraft suspension perch has previously been installed by the unmanned aircraft. In the example from FIG. 1, decision 814 may determine whether unmanned aircraft suspension perch (102) had been hung on the fan blade (114), or alternatively whether unmanned aircraft suspension perch (122) had been attached to the ceiling (113). In the example of monitoring a vehicle, decision 814 might determine whether an unmanned aircraft suspension perch had been hung from the light post or tree branch, and so forth.

Where the unmanned aircraft suspension perch has previously been installed, step 809 includes navigating the unmanned aircraft to the attachment location where the unmanned aircraft suspension perch was previously installed. Step 810 then includes attaching, using the perch interface, the unmanned aircraft to the unmanned aircraft suspension perch. At step 811, the method 800 turns OFF the flight engine, thereby causing the unmanned aircraft to suspend from the unmanned aircraft suspension perch while the mission is completed. Step 812 then detaches, again using the perch interface, the unmanned aircraft from the unmanned aircraft suspension perch. The unmanned aircraft can then optionally be returned to a landing location, charging station, or dock at step 813.

If no previously installed unmanned aircraft suspension perch is available for the job, step 803 comprises retrieving, with the unmanned aircraft, an unmanned aircraft suspension perch. In one or more embodiments, this step 803 can retrieve the unmanned aircraft suspension perch from an unmanned aircraft suspension perch storage area, such as that shown in FIG. 1. In another embodiment, this step 803 can retrieve the unmanned aircraft suspension perch from a surface to which it was previously attached and left by the unmanned aircraft. Step 803 can also include attaching the unmanned aircraft to the unmanned aircraft suspension perch at the perch interface as previously described.

Step 804 optionally includes selecting, with one or more processors carried by the unmanned aircraft, an attachment location for the unmanned aircraft suspension perch. In one or more embodiments, step 804 includes determining, with one or more sensors of the unmanned aircraft, a location where ambient light received by one or more photovoltaic cells coupled to the unmanned aircraft is optimized.

Step 805 includes navigating, with a flight engine responsive to the one or more processors, the unmanned aircraft to the attachment location. Step 806 attaches, with the unmanned aircraft, the unmanned aircraft suspension perch to the surface at the attachment location so that the mission or task can be completed.

Step 807 then detaches the perch connector from the surface, thereby releasing the unmanned aircraft suspension perch from the surface to which it was attached. Since the unmanned aircraft suspension perch is being detached from the surface, step 807 can also include engaging the flight engine of the unmanned aircraft to prevent it from falling. Step 808 can then include returning the unmanned aircraft suspension perch to an unmanned aircraft suspension perch storage area.

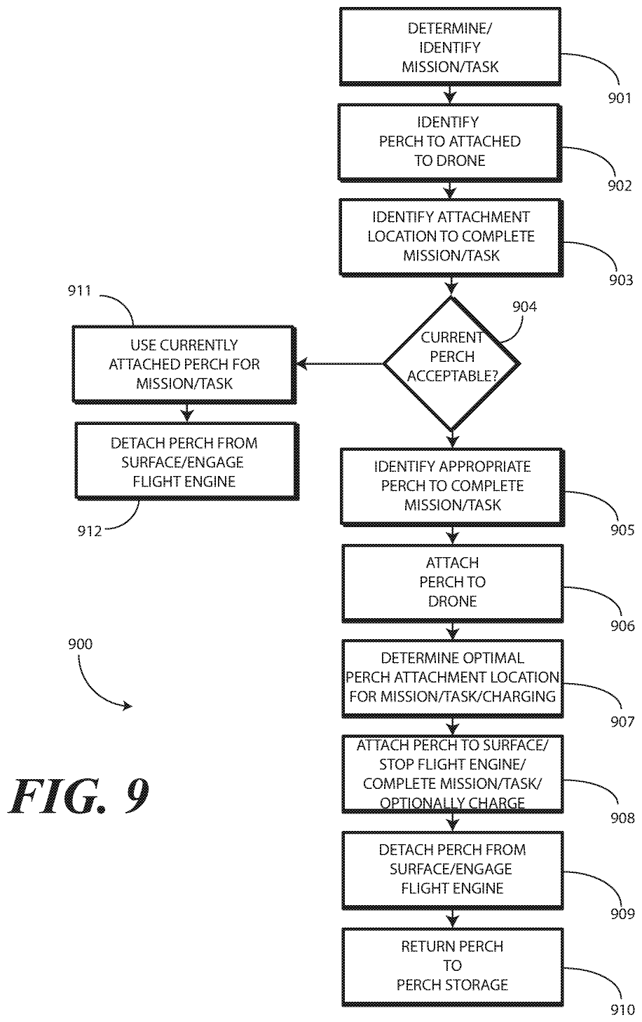

Turning now to FIG. 9, illustrated therein is yet another method 900 of attaching an unmanned aircraft suspension perch to a surface with an unmanned aircraft in accordance with one or more embodiments of the disclosure. The method 900 of FIG. 9 is used when a mission or task is requested (at step 901) of the unmanned aircraft while an unmanned aircraft suspension perch is coupled to the perch interface of the unmanned aircraft.

At step 902, the method 900 identifies a perch type (such as those described above with reference to FIG. 3) of a first unmanned aircraft suspension perch initially coupled to the unmanned aircraft. Step 903 then selects, with one or more processors carried by the unmanned aircraft, an attachment location comprising the surface.

Decision 904 then determines, with the one or more processors, whether the first unmanned aircraft suspension perch is configured to couple to the surface. Where the first unmanned aircraft suspension perch is configured to couple to the surface, the method 900 proceeds to step 911, which includes steps (805-806) of FIG. 8, namely, navigating, with a flight engine responsive to the one or more processors, the unmanned aircraft to the attachment location and attaching, with the unmanned aircraft, the first unmanned aircraft suspension perch to the surface at the attachment location. Optional step 912 can include releasing the first unmanned aircraft suspension perch while the first unmanned aircraft suspension perch remains attached to the surface at the attachment location.

However, where the first unmanned aircraft suspension perch is unsuited for coupling to the surface, the method 900 moves to step 905. At step 905, the method identifies an unmanned aircraft suspension perch suitable for the task identified at step 901. Step 906 then comprises retrieving, with the unmanned aircraft, a second unmanned aircraft suspension perch. In one or more embodiments, step 906 includes navigating, with the one or more processors, the unmanned aircraft to a suspension perch release location, such as an unmanned aircraft suspension perch storage location, and releasing the first unmanned aircraft suspension perch. If the required unmanned aircraft suspension perch is at another location, step 906 can include navigating, with the one or more processors, the unmanned aircraft to a suspension perch retrieval location, and causing the unmanned aircraft to retrieve the second unmanned aircraft suspension perch.

Step 907 then optionally selects an appropriate attachment location for the second unmanned aircraft suspension perch as previously described. Step 907 can further include navigating, with the flight engine, the unmanned aircraft to the attachment location.

Step 908 then includes attaching, with the unmanned aircraft, the second unmanned aircraft suspension perch to the surface at the attachment location so the mission identified at step 901 can be completed. In one or more embodiments, step 908 can optionally include releasing the second unmanned aircraft suspension perch while the second unmanned aircraft suspension perch remains attached to the surface at the attachment location.

Step 909 then detaches the perch connector from the surface, thereby releasing the unmanned aircraft suspension perch from the surface to which it was attached. Since the unmanned aircraft suspension perch is being detached from the surface, step 909 can also include engaging the flight engine of the unmanned aircraft to prevent it from falling. Step 910 can then include returning the unmanned aircraft suspension perch to an unmanned aircraft suspension perch storage area.

As shown and described, embodiments of the disclosure provide methods and systems for an unmanned aircraft to deploy an unmanned aircraft suspension perch and then using it. In some embodiments, a perch interface can employ a perch-to-drone connector, such as a magnet, to couple to the unmanned aircraft suspension perch. The flight engine can then apply forces to decouple the unmanned aircraft from the unmanned aircraft suspension perch. In other embodiments, a sticky substance can be used at the perch interface to perch. The flight engine can then apply forces to decouple the unmanned aircraft from the unmanned aircraft suspension perch. In still other embodiments, the perch interface can use suction cups to attach the unmanned aircraft to the unmanned aircraft suspension perch. The flight engine can then apply forces to decouple the unmanned aircraft from the unmanned aircraft suspension perch.

The methods and systems thus provide perch interface that attaches to an unmanned aircraft suspension perch, and then allows a flight engine to apply thrust or other forces to attach/detach from perch/ceiling. Attachment locations can be selected to optimize photovoltaic cell charging as well.

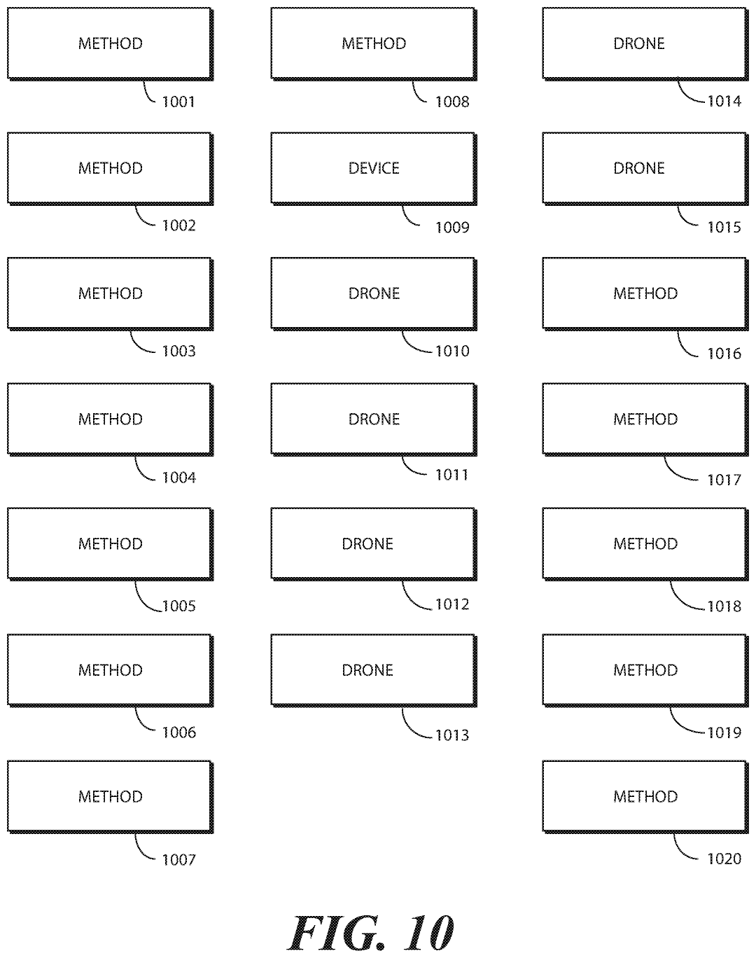

Turning now to FIG. 10, illustrated therein are various embodiments of the disclosure. At 1001, a method of attaching an unmanned aircraft suspension perch to a surface with an unmanned aircraft includes retrieving, with the unmanned aircraft, the unmanned aircraft suspension perch. At 1001, the method includes selecting, with one or more processors carried by the unmanned aircraft, an attachment location for the unmanned aircraft suspension perch. At 1001, the method includes navigating, with a flight engine responsive to the one or more processors, the unmanned aircraft to the attachment location. At 1001, the method includes attaching, with the unmanned aircraft, the unmanned aircraft suspension perch to the surface at the attachment location. At 1001, the method optionally includes releasing, with a perch interface of the unmanned aircraft, the unmanned aircraft suspension perch while the unmanned aircraft suspension perch remains attached to the surface at the attachment location.

At 1002, the method of 1001 further includes again navigating to the attachment location and attaching the unmanned aircraft to the unmanned aircraft suspension perch. At 1003, the method of 1002 includes reducing a lift force generated by the flight engine, thereby causing the unmanned aircraft to suspend from the unmanned aircraft suspension perch.

At 1004, the method of 1002 further comprises causing, with the perch interface, the unmanned aircraft suspension perch to release from the surface at the attachment location. At 1005, the method of 1004 further comprises selecting, with the one or more processors carried by the unmanned aircraft, another attachment location for the unmanned aircraft suspension perch. At 1005, the method of 1004 further comprises navigating, with the flight engine, the unmanned aircraft to the another attachment location. At 1005, the method of 1004 further comprises attaching, with the unmanned aircraft, the unmanned aircraft suspension perch to another surface at the another attachment location. At 1005, the method of 1004 further comprises releasing, with the perch interface of the unmanned aircraft, the unmanned aircraft suspension perch while the unmanned aircraft suspension perch remains attached to the another surface at the another attachment location.

At 1006, the selecting the attachment location of 1001 comprises determining, with one or more sensors of the unmanned aircraft, a location where ambient light received by one or more photovoltaic cells coupled to the unmanned aircraft is optimized. At 1007, the attaching occurring at 1001 comprises causing a hook of the unmanned aircraft suspension perch to engage the surface of the attachment location. At 1008, the attaching occurring at 1001 comprises causing a suction cup of the unmanned aircraft suspension perch to engage the surface of the attachment location. At 1009, the attaching occurring at 1001 comprises causing an electromagnet to generate a magnetic field attracting the unmanned aircraft suspension perch to the surface of the attachment location.

At 1010, an unmanned aircraft comprises a housing comprising a perch interface and an unmanned aircraft suspension perch selectively attachable to the perch interface, with the unmanned aircraft suspension perch comprising a perch connector. At 1010, the unmanned aircraft comprises a flight engine coupled to the housing. At 1010, the unmanned aircraft comprises one or more processors operable with the flight engine.

At 1010, the one or more processors cause the flight engine to navigate the unmanned aircraft to an attachment location. At 1010, the one or more processors cause the flight engine to cause the perch connector to couple to a surface at the attachment location. At 1010, the one or more processors cause the perch interface to release the unmanned aircraft suspension perch from the perch interface while the unmanned aircraft suspension perch remains attached to the surface at the attachment location.

At 1011, the unmanned aircraft of 1010 further comprises one or more photovoltaic cells and one or more sensors coupled to the unmanned aircraft. At 1011, the one or more processors select the attachment location by determining, with the one or more sensors, where light reception by the one or more photovoltaic cells will be optimized.

At 1012, the one or more processors of 1010 also cause the flight engine to navigate to the attachment location. At 1012, the one or more processors of 1010 also cause the flight engine to cause the perch interface to mechanically engage the unmanned aircraft suspension perch. At 1012, the one or more processors of 1010 also cause the perch connector to release the unmanned aircraft suspension perch from the surface at the attachment location.

At 1013, the perch interface of 1010 comprises one of an adhesive coupling, a suction coupling, a hook and loop fastener coupling, a latch, or a magnetic coupling. At 1014, the perch connector of 1010 comprises one of a hook, an electromagnet, or a suction cup. At 1015, the one or more processors of 1010 further turning the flight engine OFF when both the perch connector is coupled to the surface at the attachment location and the perch interface is coupled to the unmanned aircraft suspension perch, thereby causing the unmanned aircraft to suspend from the surface via the unmanned aircraft suspension perch.

At 1016, a method of attaching an unmanned aircraft suspension perch to a surface with an unmanned aircraft comprises identifying a perch type of a first unmanned aircraft suspension perch initially coupled to the unmanned aircraft. At 1016, the method comprises selecting, with one or more processors carried by the unmanned aircraft, an attachment location comprising the surface. At 1016, the method comprises determining, with the one or more processors, whether the first unmanned aircraft suspension perch is configured to couple to the surface.

Where the first unmanned aircraft suspension perch is configured to couple to the surface, the method of 1016 includes navigating, with a flight engine responsive to the one or more processors, the unmanned aircraft to the attachment location and attaching, with the unmanned aircraft, the first unmanned aircraft suspension perch to the surface at the attachment location. Where the first unmanned aircraft suspension perch is unsuited for coupling to the surface, the method of 1016 includes retrieving, with the unmanned aircraft, a second unmanned aircraft suspension perch, navigating, with the flight engine, the unmanned aircraft to the attachment location, and attaching, with the unmanned aircraft, the second unmanned aircraft suspension perch to the surface at the attachment location.

At 1017, the method of 1016 further comprises, where the first unmanned aircraft suspension perch is configured to couple to the surface, releasing the first unmanned aircraft suspension perch while the first unmanned aircraft suspension perch remains attached to the surface at the attachment location. At 1018, the method of 1016 further comprises, where the first unmanned aircraft suspension perch is unsuited for coupling to the surface, releasing the second unmanned aircraft suspension perch while the second unmanned aircraft suspension perch remains attached to the surface at the attachment location.

At 1019, the method of 1016 further comprises, where the first unmanned aircraft suspension perch is unsuited for coupling to the surface, navigating, with the one or more processors, the unmanned aircraft to a suspension perch release location, and releasing the first unmanned aircraft suspension perch. At 1020, the method of 1019 further comprises navigating, with the one or more processors, the unmanned aircraft to a suspension perch retrieval location, and causing the unmanned aircraft to retrieve the second unmanned aircraft suspension perch.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method of attaching an unmanned aircraft suspension perch to a surface with an unmanned aircraft, the method comprising:
retrieving, with the unmanned aircraft, the unmanned aircraft suspension perch;
selecting, with one or more processors carried by the unmanned aircraft, an attachment location for the unmanned aircraft suspension perch;
navigating, with a flight engine responsive to the one or more processors, the unmanned aircraft to the attachment location;
attaching, with the unmanned aircraft, the unmanned aircraft suspension perch to the surface at the attachment location; and
releasing, with a perch interface of the unmanned aircraft, the unmanned aircraft suspension perch while the unmanned aircraft suspension perch remains attached to the surface at the attachment location.

2. The method of claim 1, further comprising again navigating to the attachment location and attaching the unmanned aircraft to the unmanned aircraft suspension perch.

3. The method of claim 2, further comprising reducing a lift force generated by the flight engine, thereby causing the unmanned aircraft to suspend from the unmanned aircraft suspension perch.

4. The method of claim 2, further comprising causing, with the perch interface, the unmanned aircraft suspension perch to release from the surface at the attachment location.

5. The method of claim 4, further comprising:
selecting, with the one or more processors carried by the unmanned aircraft, another attachment location for the unmanned aircraft suspension perch;
navigating, with the flight engine, the unmanned aircraft to the another attachment location;
attaching, with the unmanned aircraft, the unmanned aircraft suspension perch to another surface at the another attachment location; and
releasing, with the perch interface of the unmanned aircraft, the unmanned aircraft suspension perch while the unmanned aircraft suspension perch remains attached to the another surface at the another attachment location.

6. The method of claim 1, wherein the selecting the attachment location for the unmanned aircraft suspension perch comprising determining, with one or more sensors of the unmanned aircraft, a location where ambient light received by one or more photovoltaic cells coupled to the unmanned aircraft is optimized.

7. The method of claim 1, wherein the attaching the unmanned aircraft suspension perch to the surface at the attachment location comprises causing a hook of the unmanned aircraft suspension perch to engage the surface of the attachment location.

8. The method of claim 1, wherein the attaching the unmanned aircraft suspension perch to the surface at the attachment location comprises causing a suction cup of the unmanned aircraft suspension perch to engage the surface of the attachment location.

9. The method of claim 1, wherein the attaching the unmanned aircraft suspension perch to the surface at the attachment location comprises causing an electromagnet to generate a magnetic field attracting the unmanned aircraft suspension perch to the surface of the attachment location.

10. An unmanned aircraft, comprising:
a housing comprising a perch interface;
an unmanned aircraft suspension perch selectively attachable to the perch interface, the unmanned aircraft suspension perch comprising a perch connector;
a flight engine coupled to the housing; and
one or more processors operable with the flight engine, the one or more processors causing:
the flight engine to navigate the unmanned aircraft to an attachment location;
the flight engine to cause the perch connector to couple to a surface at the attachment location; and
the perch interface to release the unmanned aircraft suspension perch from the perch interface while the unmanned aircraft suspension perch remains attached to the surface at the attachment location.

11. The unmanned aircraft of claim 10, further comprising one or more photovoltaic cells and one or more sensors coupled to the unmanned aircraft, the one or more processors selecting the attachment location by determining, with the one or more sensors, where light reception by the one or more photovoltaic cells will be optimized.

12. The unmanned aircraft of claim 10, the one or more processors also causing:
the flight engine to navigate to the attachment location;
the flight engine to cause the perch interface to mechanically engage the unmanned aircraft suspension perch; and
the perch connector to release the unmanned aircraft suspension perch from the surface at the attachment location.

13. The unmanned aircraft of claim 10, the perch interface comprising one of an adhesive coupling, a suction coupling, a hook and loop fastener coupling, a latch, or a magnetic coupling.

14. The unmanned aircraft of claim 10, the perch connector comprising one of a hook, an electromagnet, or a suction cup.

15. The unmanned aircraft of claim 10, the one or more processors further turning the flight engine OFF when both the perch connector is coupled to the surface at the attachment location and the perch interface is coupled to the unmanned aircraft suspension perch, thereby causing the unmanned aircraft to suspend from the surface via the unmanned aircraft suspension perch.

16. A method of attaching an unmanned aircraft suspension perch to a surface with an unmanned aircraft, the method comprising:
identifying a perch type of a first unmanned aircraft suspension perch initially coupled to the unmanned aircraft;
selecting, with one or more processors carried by the unmanned aircraft, an attachment location comprising the surface;
determining, with the one or more processors, whether the first unmanned aircraft suspension perch is configured to couple to the surface;
where the first unmanned aircraft suspension perch is configured to couple to the surface:
navigating, with a flight engine responsive to the one or more processors, the unmanned aircraft to the attachment location; and
attaching, with the unmanned aircraft, the first unmanned aircraft suspension perch to the surface at the attachment location; and
where the first unmanned aircraft suspension perch is unsuited for coupling to the surface:
retrieving, with the unmanned aircraft, a second unmanned aircraft suspension perch;
navigating, with the flight engine, the unmanned aircraft to the attachment location; and
attaching, with the unmanned aircraft, the second unmanned aircraft suspension perch to the surface at the attachment location.

17. The method of claim 16, further comprising, where the first unmanned aircraft suspension perch is configured to couple to the surface, releasing the first unmanned aircraft suspension perch while the first unmanned aircraft suspension perch remains attached to the surface at the attachment location.

18. The method of claim 16, further comprising, where the first unmanned aircraft suspension perch is unsuited for coupling to the surface, releasing the second unmanned aircraft suspension perch while the second unmanned aircraft suspension perch remains attached to the surface at the attachment location.

19. The method of claim 16, further comprising, where the first unmanned aircraft suspension perch is unsuited for coupling to the surface, navigating, with the one or more processors, the unmanned aircraft to a suspension perch release location, and releasing the first unmanned aircraft suspension perch.

20. The method of claim 19, further comprising navigating, with the one or more processors, the unmanned aircraft to a suspension perch retrieval location, and causing the unmanned aircraft to retrieve the second unmanned aircraft suspension perch.
